(19) United States
(12) Patent Application Publication
(10) Pub. No.: US 2012/0125074 A1
(43) Pub. Date: May 24, 2012

(54) Tool head device for crimping rings and clamps

(75) Inventor: Lei Zhang, Tianjin (CN)

(73) Assignee: LINK-TECH (TIANJIN) METAL PRODUCTS CO., LTD.

(21) Appl. No.: 12/970,455

(22) Filed: Dec. 16, 2010

(30) Foreign Application Priority Data
Nov. 18, 2010 (CN) 201020613800.8

(51) Int. Cl. B25B 27/02

(52) U.S. Cl. 72/470

(57) ABSTRACT

A tool head device for crimping rings and clamps includes a clamp head member which is formed by connecting a left clamp head with a right clamp head via two covers, a clamp head shaft and two cover pins. Each of the left clamp head and the right clamp head has a clamp jaw at a top end thereof. Each of the left clamp head and the right clamp head has a concaved inner sidewall at an end portion thereof, the two concaved inner sidewalls form an insert cavity, an insert component is provided within the insert cavity. An end of the left clamp head is connected with that of the right clamp head by connecting pins and connecting boards. It can be used to crimp rings and clamps. It has the simple structure, facilitates operating and carrying, reducing the cost, and improves the efficiency of installing.

### BACKGROUND OF THE PRESENT INVENTION

1. Field of Invention

The present invention relates to a hardware tool, and more particularly to a tool head device for crimping rings and clamps.

2. Description of Related Arts

It is well known that PEX pipe and aluminum plastic composite pipe are widely used as the conveying pipe of water supply, oil supply and gas supply. In general, the diameter of the pipe is ⅜ inch, ½ inch, ¾ inch, 1 inch and so on. Therefore, the interconnections among pipes are involved while installing these pipes. The most common pipe joint currently used by the public is a copper joint body having two symmetrical ends for inserting the PEX pipe or aluminum plastic composite pipe into the joint body, then a deformable annular fastener is fixed with the joint body by the clamping pliers, the fastener deforms during the fixation for tightly fixing the fastener with the outer wall of the PEX pipe or aluminum plastic composite pipe. However, the existing rings and clamps of the clamping pliers are detached from each other. There are the special crimping clamp pliers and crimping ring pliers. The crimping clamp pliers have the clamp head device, and the crimping ring pliers have the ring head device. It is inconvenient to use, and needs taking two tools while working, so it is not only inconvenient to carry, but also affects the efficiency of the construction.

### SUMMARY OF THE PRESENT INVENTION

An object of the present invention is to provide a tool head device for crimping rings and clamps, which has simple structure, convenient operation and is capable of improving the efficiency of the construction.

Accordingly, in order to accomplish the above object, the present invention provides a tool head device for crimping rings and clamps, comprising a clamp head member which is formed by connecting a left clamp head with a right clamp head via two covers, a clamp head shaft and two cover pins, characterized in that each of the left clamp head and the right clamp head has a clamp jaw for clamping the clamp at a top end thereof, each of the left clamp head and the right clamp head has a concaved inner sidewall at an end portion thereof, the concaved inner sidewall of the left clamp head and the concaved inner sidewall of the right clamp head form an insert cavity, an insert component is provided within the insert cavity, the other end of the left clamp head is connected with that of the right clamp head by connecting pins and connecting boards.

Preferably, the insert component comprises a left insert and a right insert, wherein the left insert and the right insert are connected with the left clamp head and the right clamp head respectively by an insert positioning shaft, an insert positioning plate and an insert driving pin.

Preferably, the clamp jaw is a protruding wedge-shaped jaw.

Preferably, each of the left clamp head and the right clamp head has a fastening hole and a mounting hole for mounting the insert, wherein the mounting hole is an inward concave groove, and a spring is provided within the groove.

Preferably, each of the left clamp head and the right clamp head has at least a technical hole for reducing the weight of the clamp head.

Preferably, each of the left clamp head and the right clamp head has a connecting hole at a bottom thereof for mounting the connecting boards.

Preferably, each of the left insert and the right insert has a half-oblong opening at a periphery thereof.

The advantages and positive effects of the present invention are shown as below. The present invention provides a tool head device integrating the clamp head device and the ring head device. It can be used to crimp rings and clamps. It has simple structure. Moreover, a tool using the present invention replaces two tools using the conventional structure, thereby reducing the cost, facilitating carrying, and improving the working efficiency. The insert component of the tool head device has an opening at the periphery thereof, a concaved platform is provided above the opening. While installing or replacing the insert, the insert driving pin is pressed, the insert is taken out, and then a new insert is installed, thereby the new insert is tightly fastened by the spring. The present invention has the simple operation, facilitates replacing the insert and improves the efficiency of installing.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a tool head device for crimping rings and clamps according to a first preferred embodiment of the present invention.

FIG. 2 is an exploded view of FIG. 1.

FIG. 3 is an exploded view of a tool head device for crimping rings and clamps according to a second preferred embodiment of the present invention.

FIG. 4 is a schematic view of the present invention, showing the replacement of the insert while the clamp jaw of the present invention is open.

FIG. 5 is a rear perspective view of a clamp head.

In the drawings, 1: a clamp head member; 1-1: a left clamp head; 1-2: a right clamp head; 1-3: a clamp head shaft; 1-4: a wedge-shaped clamp jaw; 1-5: a technical hole; 1-6: a connecting hole; 1-7: a mounting hole; 1-8: a fastening hole; 2: an insert component; 2-1: a left insert; 2-2: a right insert; 2-3: an insert driving pin; 2-4: an insert positioning shaft; 2-5: an insert positioning plate; 2-6: a spring; 2-7: an opening; 3: a cover; 4: a cover pin; 5: a connecting board; 6: a connecting pin.

### DETAILED DESCRIPTION OF THE PREFERRED EMBODIMENT

The present invention is further detailedly explained with the accompanying drawings.

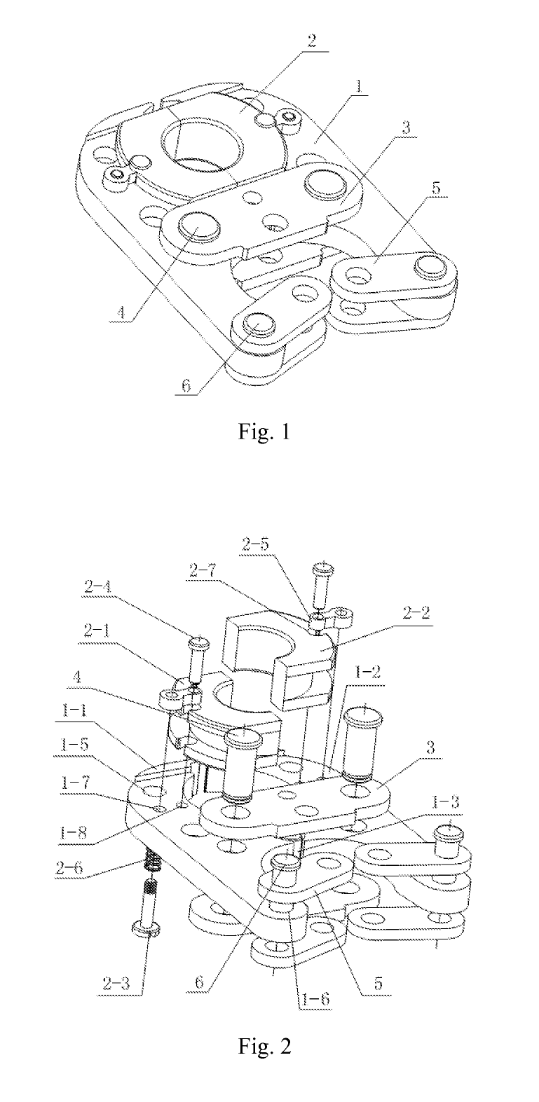

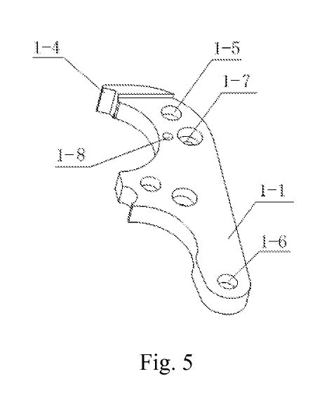

Referring to FIGS. 1, 2 and 5 of the drawings, a tool head device according to a first preferred embodiment of the present invention is illustrated, wherein the tool head device, adapted for crimping rings, comprises a clamp head member 1 which is formed by connecting a left clamp head 1-1 with a right clamp head 1-2 via two covers 3, a clamp head shaft 1-3 and two cover pins 4. Each of the left clamp head 1-1 and the right clamp head 1-2 has a clamp jaw at a top end thereof for crimping clamps, wherein the clamp jaw is a protruding wedge-shaped jaw 1-4. Each of the left clamp head 1-1 and the right clamp head 1-2 has a concaved inner sidewall at an end portion thereof. The concaved inner sidewall of the left clamp head and the concaved inner sidewall of the right clamp head form an insert cavity. An insert component 2 is provided within the insert cavity. The other end of the left clamp head is connected with that of the right clamp head by four connecting boards 5 and two connecting pins 6. The insert component 2 comprises a left insert 2-1 and a right insert 2-2, wherein the left insert 2-1 and the right insert 2-2 are connected with the left clamp head 1-1 and the right clamp head 1-2 respectively by an insert positioning shaft 2-4, an insert positioning plate 2-5 and an insert driving pin 2-3. Each of the left clamp head 1-1 and the right clamp head 1-2 has a fastening hole 1-8 and a mounting hole 1-7 which are adapted for mounting the insert, wherein the mounting hole 1-7 is an inward concave groove, that is to say, a diameter of the mounting hole 1-7 on a first surface of the left clamp head 1-1 is larger than a diameter of the mounting hole 1-7 on a second surface opposite to the first surface of the left clamp head 1-1, a spring 2-6 is provided within the groove, as shown in FIG. 5. The left insert 2-1 has a half-oblong opening 2-7 at a periphery thereof for matching with the insert positioning plate 2-5, such that the insert positioning shaft 2-4 passes through one end of the insert positioning plate 2-5, the half-oblong opening 2-7 and the mounting hole 1-7 to connect the left insert 2-1 with the left clamp head 1-1. Similarly, the right insert 2-2 has a half-oblong opening 2-7 at a periphery thereof for matching with the insert positioning plate 2-5, such that the insert positioning shaft 2-4 passes through one end of the insert positioning plate 2-5, the half-oblong opening 2-7 and the mounting hole 1-7 to connect the right insert 2-2 with the right clamp head 1-2. Furthermore, each of the left clamp head 1-1 and the right clamp head 1-2 has two technical holes 1-5 therein for reducing the weight of the clamp head, and a connecting hole 1-6 at a bottom thereof for mounting the connecting boards 5.

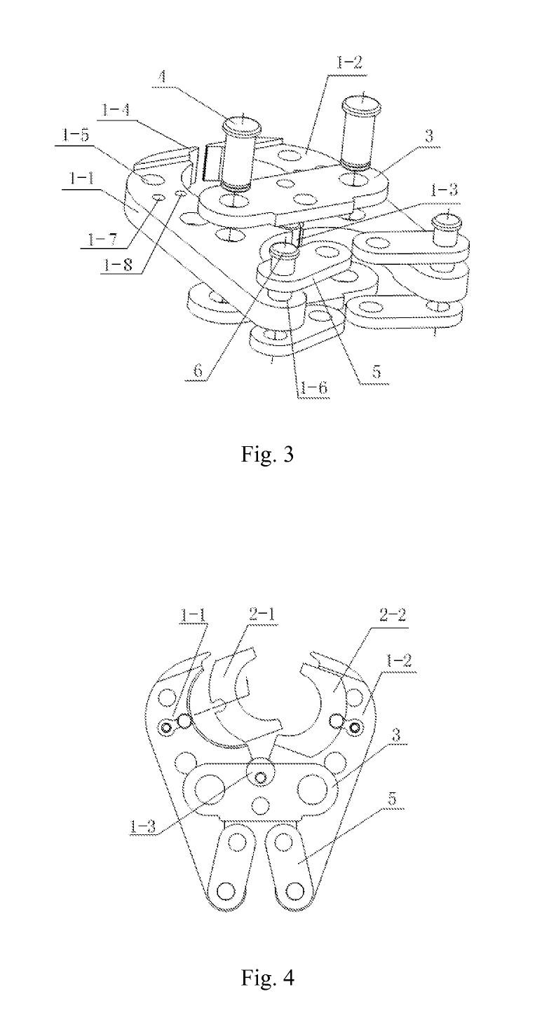

Referring to FIG. 3, a tool head device according to a second preferred embodiment of the present invention is illustrated, wherein the tool head device, adapted for crimping clamps, comprises a clamp head member 1 which is formed by connecting a left clamp head 1-1 with a right clamp head 1-2 via two covers 3, a clamp head shaft 1-3 and two cover pins 4. Each of the left clamp head 1-1 and the right clamp head 1-2 has a clamp jaw for clamping the clamp at a top end thereof, wherein the clamp jaw is a protruding wedge-shaped jaw 1-4. Each of the left clamp head 1-1 and the right clamp head 1-2 has a concaved inner sidewall at an end portion thereof. The concaved inner sidewall of the left clamp head and the concaved inner sidewall of the right clamp head form an insert cavity. The other end of the left clamp head is connected with that of the right clamp head by four connecting boards 5 and two connecting pins 6. Each of the left clamp head 1-1 and the right clamp head 1-2 has a fastening hole 1-8 and a mounting hole 1-7 which are adapted for mounting the insert, wherein the mounting hole 1-7 is an inward concave groove. Furthermore, each of the left clamp head 1-1 and the right clamp head 1-2 has two technical holes 1-5 therein for reducing the weight of the clamp head, and a connecting hole 1-6 at a bottom thereof for mounting the connecting boards 5.

The working principle of the present invention is illustrated as below.

Referring to FIG. 4, when the present invention is used to crimp rings, the left insert 2-1 and the right insert 2-2 are installed within the insert cavity for clamping the copper ring. When the clamp head of the clamping tool needs replacing the inserts with different specifications, only the insert driving pin is pressed, so that the insert positioning plate is broken away from the insert, and then the insert is taken out by pushing it along the direction of the opening, and then a new insert is installed within the insert cavity, thereby the new insert is tightly fastened by the spring. As a result, the insert is replaced. The present invention has a simple operation, facilitates replacing the insert and improves the efficiency of installing. When the present invention is used to crimp clamps, no insert needs installing, or the insert installed to the tool is taken off for clamping the clamp.

The present invention can be used as not only a head device of a manual tool, but a head device of an electric tool. When the tool head device of the present invention is connected with a manual tool, the connecting boards 5 will be removed. When the tool head device of the present invention is connected with an electric tool, the tool head device of the present invention is directly connected with the electric tool.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A tool head device for crimping rings and clamps, comprising:
a clamp head member comprising:
a left clamp head having a left clamp jaw at a top end thereof, a left concaved inner sidewall at an end portion thereof, and a left connecting hole at a bottom end thereof for connecting a body of manual tool or power tool; and
a right clamp head having a right clamp jaw at a top end thereof, a right concaved inner sidewall at an end portion thereof, and a right connecting hole at a bottom end thereof for connecting a body of manual tool or power tool,
wherein said left concaved inner sidewall and said right concaved inner sidewall form an insert cavity;
two covers;
a clamp head shaft provided between said two covers; and
two cover pins,
wherein said two covers are opposite to each other, in such a manner that one of said two cover pins passes through one of said two covers, said left clamp head and the other cover in turn, and the other cover pin passes through one of said two covers, said right clamp head and the other cover in turn, so that said left clamp head is connected with said right clamp head by said two covers, said clamp head shaft and said two cover pins.

2. The tool head device, as recited in claim 1, further comprising four connecting boards comprising two left connecting boards and two right connecting boards, and two connecting pins comprising a left connecting pin and a right connecting pin, wherein said two left connecting boards are opposite to each other, said two right connecting boards are opposite to each other, in such a manner that said left connecting pin passes through one of said two left connecting boards, said left connecting hole and the other left connecting board in turn, and said right connecting pin passes through one of said two right connecting boards, said right connecting hole and the other right connecting board in turn, so that said bottom end of said left clamp head is connected with that of said right to clamp head by said four connecting boards and said two connecting pins.

3. The tool head device, as recited in claim 1, wherein each of said left clamp jaw and said right clamp jaw is a protruding wedge-shaped jaw.

4. The tool head device, as recited in claim 2, wherein each of said left clamp jaw and said right clamp jaw is a protruding wedge-shaped jaw.

5. The tool head device, as recited in claim 1, wherein each of said left clamp head and said right clamp head has at least one technical hole therein for reducing a weight of the tool head device.

6. The tool head device, as recited in claim 2, wherein each of said left clamp head and said right clamp head has at least one technical hole therein for reducing a weight of the tool head device.

7. The tool head device, as recited in claim 3, wherein each of said left clamp head and said right clamp head has at least one technical hole therein for reducing a weight of the tool head device.

8. The tool head device, as recited in claim 4, wherein each of said left clamp head and said right clamp head has at least one technical hole therein for reducing a weight of the tool head device.

9. The tool head device, as recited in claim 1, further comprising an insert component, provided within said insert cavity, comprising a left insert, a right insert, two insert positioning shafts, two insert positioning plates, two insert driving pins and two springs,
wherein said left insert has a left half-oblong opening at a periphery thereof, and said right insert has a right half-oblong opening at a periphery thereof,
wherein said left clamp head has a left fastening hole and a left mounting hole for mounting said insert component, and said right clamp head has a right fastening hole and a right mounting hole for mounting said insert component, in such a manner that one of said insert positioning shafts passes through one end of one of said insert positioning plates, said left half-oblong opening and said left mounting hole to connect said left insert with said left clamp head, and the other insert positioning shaft passes through one end of the other insert positioning plate, said right half-oblong opening and said right mounting hole to connect said right insert with said right clamp head, so that said insert component is connected with said clamp head member,
wherein said two springs are provided within said left and right mounting holes respectively.

10. The tool head device, as recited in claim 2, further comprising an insert component, provided within said insert cavity, comprising a left insert, a right insert, two insert positioning shafts, two insert positioning plates, two insert driving pins and two springs,
wherein said left insert has a left half-oblong opening at a periphery thereof, and said right insert has a right half-oblong opening at a periphery thereof,
wherein said left clamp head has a left fastening hole and a left mounting hole for mounting said insert component, and said right clamp head has a right fastening hole and a right mounting hole for mounting said insert component, in such a manner that one of said insert positioning shafts passes through one end of one of said insert positioning plates, said left half-oblong opening and said left mounting hole to connect said left insert with said left clamp head, and the other insert positioning shaft passes through one end of the other insert positioning plate, said right half-oblong opening and said right mounting hole to connect said right insert with said right clamp head, so that said insert component is connected with said clamp head member,
wherein said two springs are provided within said left and right mounting holes respectively.

11. The tool head device, as recited in claim 3, further comprising an insert component, provided within said insert cavity, comprising a left insert, a right insert, two insert positioning shafts, two insert positioning plates, two insert driving pins and two springs,
wherein said left insert has a left half-oblong opening at a periphery thereof, and said right insert has a right half-oblong opening at a periphery thereof,
wherein said left clamp head has a left fastening hole and a left mounting hole for mounting said insert component, and said right clamp head has a right fastening hole and a right mounting hole for mounting said insert component, in such a manner that one of said insert positioning shafts passes through one end of one of said insert positioning plates, said left half-oblong opening and said left mounting hole to connect said left insert with said left clamp head, and the other insert positioning shaft passes through one end of the other insert positioning plate, said right half-oblong opening and said right mounting hole to connect said right insert with said right clamp head, so that said insert component is connected with said clamp head member,
wherein said two springs are provided within said left and right mounting holes respectively.

12. The tool head device, as recited in claim 4, further comprising an insert component, provided within said insert cavity, comprising a left insert, a right insert, two insert positioning shafts, two insert positioning plates, two insert driving pins and two springs,
wherein said left insert has a left half-oblong opening at a periphery thereof, and said right insert has a right half-oblong opening at a periphery thereof,
wherein said left clamp head has a left fastening hole and a left mounting hole for mounting said insert component, and said right clamp head has a right fastening hole and a right mounting hole for mounting said insert component, in such a manner that one of said insert positioning shafts passes through one end of one of said insert positioning plates, said left half-oblong opening and said left mounting hole to connect said left insert with said left clamp head, and the other insert positioning shaft passes through one end of the other insert positioning plate, said right half-oblong opening and said right mounting hole to connect said right insert with said right clamp head, so that said insert component is connected with said clamp head member,
wherein said two springs are provided within said left and right mounting holes respectively.

13. The tool head device, as recited in claim 5, further comprising an insert component, provided within said insert cavity, comprising a left insert, a right insert, two insert positioning shafts, two insert positioning plates, two insert driving pins and two springs,
wherein said left insert has a left half-oblong opening at a periphery thereof, and said right insert has a right half-oblong opening at a periphery thereof,
wherein said left clamp head has a left fastening hole and a left mounting hole for mounting said insert component, and said right clamp head has a right fastening hole and a right mounting hole for mounting said insert component, in such a manner that one of said insert positioning shafts passes through one end of one of said insert positioning plates, said left half-oblong opening and said left mounting hole to connect said left insert with said left clamp head, and the other insert positioning shaft passes through one end of the other insert positioning plate, said right half-oblong opening and said right mounting hole to connect said right insert with said right clamp head, so that said insert component is connected with said clamp head member,
wherein said two springs are provided within said left and right mounting holes respectively.

14. The tool head device, as recited in claim 6, further comprising an insert component, provided within said insert cavity, comprising a left insert, a right insert, two insert positioning shafts, two insert positioning plates, two insert driving pins and two springs,
wherein said left insert has a left half-oblong opening at a periphery thereof, and said right insert has a right half-oblong opening at a periphery thereof,
wherein said left clamp head has a left fastening hole and a left mounting hole for mounting said insert component, and said right clamp head has a right fastening hole and a right mounting hole for mounting said insert component, in such a manner that one of said insert positioning shafts passes through one end of one of said insert positioning plates, said left half-oblong opening and said left mounting hole to connect said left insert with said left clamp head, and the other insert positioning shaft passes through one end of the other insert positioning plate, said right half-oblong opening and said right mounting hole to connect said right insert with said right clamp head, so that said insert component is connected with said clamp head member,
wherein said two springs are provided within said left and right mounting holes respectively.

15. The tool head device, as recited in claim 9, wherein each of said left mounting hole and said right mounting hole is an inward concave groove, that is to say, a diameter of said left mounting hole on a first surface of said left clamp head is larger than a diameter of said left mounting hole on a second surface opposite to said first surface of said left clamp head, and a diameter of said right mounting hole on a first surface of said right clamp head is larger than a diameter of said right mounting hole on a second surface opposite to said first surface of said right clamp head.

16. The tool head device, as recited in claim 10, wherein each of said left mounting hole and said right mounting hole is an inward concave groove, that is to say, a diameter of said left mounting hole on a first surface of said left clamp head is larger than a diameter of said left mounting hole on a second surface opposite to said first surface of said left clamp head, and a diameter of said right mounting hole on a first surface of said right clamp head is larger than a diameter of said right mounting hole on a second surface opposite to said first surface of said right clamp head.

17. The tool head device, as recited in claim 11, wherein each of said left mounting hole and said right mounting hole is an inward concave groove, that is to say, a diameter of said left mounting hole on a first surface of said left clamp head is larger than a diameter of said left mounting hole on a second surface opposite to said first surface of said left clamp head, and a diameter of said right mounting hole on a first surface of said right clamp head is larger than a diameter of said right mounting hole on a second surface opposite to said first surface of said right clamp head.

18. The tool head device, as recited in claim 12, wherein each of said left mounting hole and said right mounting hole is an inward concave groove, that is to say, a diameter of said left mounting hole on a first surface of said left clamp head is larger than a diameter of said left mounting hole on a second surface opposite to said first surface of said left clamp head, and a diameter of said right mounting hole on a first surface of said right clamp head is larger than a diameter of said right mounting hole on a second surface opposite to said first surface of said right clamp head.

19. The tool head device, as recited in claim 13, wherein each of said left mounting hole and said right mounting hole is an inward concave groove, that is to say, a diameter of said left mounting hole on a first surface of said left clamp head is larger than a diameter of said left mounting hole on a second surface opposite to said first surface of said left clamp head, and a diameter of said right mounting hole on a first surface of said right clamp head is larger than a diameter of said right mounting hole on a second surface opposite to said first surface of said right clamp head.

20. The tool head device, as recited in claim 14, wherein each of said left mounting hole and said right mounting hole is an inward concave groove, that is to say, a diameter of said left mounting hole on a first surface of said left clamp head is larger than a diameter of said left mounting hole on a second surface opposite to said first surface of said left clamp head, and a diameter of said right mounting hole on a first surface of said right clamp head is larger than a diameter of said right mounting hole on a second surface opposite to said first surface of said right clamp head.
